(19) United States
(12) Patent Application Publication
(10) Pub. No.: US 2002/0067486 A1
(43) Pub. Date: Jun. 6, 2002

(54) Solderability assessment

(76) Inventors: LeRoy S. Forney, Philadelphia, PA (US); G. Christopher Thierolf, Flourtown, PA (US); Brian J. Toleno, Secane, PA (US)

Correspondence Address: Robert A. Koons, Jr., PEPPER HAMILTON LLP, 3000 Two Logan Square, Eighteenth and Arch Streets, Philadelphia, PA, 19103-2799, US

(21) Appl. No.: 09/962,419

(22) Filed: Sep. 25, 2001

Related U.S. Application Data
(60) Provisional application No. 60/234,969, filed on Sep. 25, 2000.

(51) Int. Cl. G01N 21/55

(52) U.S. Cl. 356/448

(57) ABSTRACT

A method for assessing the solderability of metals by spectroscopy is provided. The method includes illuminating the sample and collecting and analyzing the spectral characteristics of the sample. Specifically, the present invention effectively solves the problem of evaluating the solderability of preservative coated metals. An apparatus and software are also provided which are in particular useful to assess the solderability of preservative coated metals.

### FIELD OF THE INVENTION

This invention pertains to a method and apparatus for assessing the solderability of metals, especially preservative coated metals, using spectroscopy techniques.

### BACKGROUND OF THE INVENTION

Poor solderability is a big problem in the electroplating and electronics industry, e.g., computer manufacturing. It is the single most important factor in the formation of reliable solder joints for printed circuit assembly. As the solder interacts with the base metals, a good metallurgical bond is obtained and metallic continuity is established. This continuity is good for electrical and heat conductivity as well as for strength. Good solderability or good wetting occurs when the solder flows well to form a continuous, unbroken film free of pinholes and depressions.

Manufacturing yields and the overall reliability of electronics manufacture are significantly impacted by solderability issues. These issues include fine pitch component solderability, component and board solderability under organic solder preservative (OSP) coatings and metallic platings, the time required for solderability testing, and the ability to troubleshoot solderability problems. The cost impact associated with these problems is correspondingly large.

The cost of reworking defective solder joints is estimated to be 4-5 times the cost of making a proper solder joint. Therefore, manufacturers of electronic assemblies have been investigating means for reducing defect rates with the ultimate goal to achieve a significant cost savings and increase the overall reliability of electronic assemblies.

The quality of solderability of metal surfaces such as thin layers of copper on printed circuit boards (PCBs) is affected by oxidation of the base metal, e.g., copper. Copper surface oxide structure and quantity have a direct link to solderability, as determined by the ability of the metal surface to be wetted by molten solder. Solderability is significantly affected by the presence of oxidized metal layers on the base metals. In the printed circuit board manufacturing process, there can be a significant interval between the production of the board substrate and the soldering of the various components to its surfaces. In fact, these two operations often take place at different sites. During the period of shipment and storage of the substrates, the external copper circuitry must be protected against oxidation in order to avoid problems with the subsequent soldering.

Currently, abrasives and fluxes are used during the soldering process in an attempt to resolve the problem. Fluxes are designed to remove surface oxides and then to protect the surface from reoxidation during subsequent soldering processes. However, it has been found that even after fluxes are employed, highly oxidized base metals or coatings experienced degradation in solderability. Therefore, even when fluxes are employed, it is important to assess the solderability properties of a given metal.

To prevent the oxidation and corrosion a protective coating is often applied on the metals. Tin-lead and some other metallic materials are used as protective coatings to prolong solderability of base materials. The deposition of either tin or tin-lead alloy on a clean surface (often copper or nickel-iron in electronics) prevents oxidation or other corrosion of the surface, and thus preserves its solderability. Such coatings (usually 5 -8 micrometers thick) are applied to the leads or pads of electronic components, and also to the tracks of printed circuit boards; the application may be by electroplating (for example ‘barrel plating’ of small components), hot air solder leveling (HASL), or dipping into a bath of the molten alloy.

A problem, however, arises with the use of metallic protective coatings in that these coatings are subject to oxidation, corrosion and the growth of intermetallics, all of which can detrimentally effect the solderability properties of a substrate. Also, because of the environmental concerns associated with lead, and the fact that tin-lead coatings do not provide the flat, planar surfaces required for surface mount assembly, there is a rapidly growing trend towards the replacement of tin-lead by alternative means. Thus, this method is deficient due to environmental and safety concerns concerning lead; the need for a coplanar surface; ionic contamination of the surface; fine-pitch device assembly; reliability and cost. As a result, organic and organo-metallic coatings are increasingly being applied over bare copper as an approach to improve the co-planarity of circuit boards used in surface mount assemblies. Current methods of electroplating and hot-air solder leveling (HASL) do not provide the coplanarity needed to manufacture high density assemblies and are typically more costly than depositing organic solder preservative (OSP) coatings over bare copper.

The OSPs form a film that is not easily visible to the naked eye when applied. This film is much thinner than tin-lead coatings. A typical thickness is 0.3 to 0.5 μm, although some are applied at only 2 to 5 nm. Azole-type compounds have been found to be particularly effective for this purpose, and there are numerous patents covering various organic compounds consisting of benzimidazoles, imidazole, alkylimidazoles, benzotriazozles and alkyltriazoles, substituted or unsubstituted derivatives thereof. U.S. Pat. Nos. 5,658,611; 5,858,074; 5,795,409 and 5,735,973 disclose for example surface protection preservatives such as benzimidazole derivatives for printed circuit board and process of forming surface protection films. U.S. Pat. Nos. 3,933,531; 4,373,656; 5,173,130; 5,960,251; 5,960,251; 5,498,301; 5,496,590 in addition to traditional OSPs also disclose films comprising solder-wettable metals or metal solders and oxygen-scavenging agents consisting of acidic alkali metal bisulfites, acidic aromatic amines and ethylene glycol. Organic metal is another coating concept which in essence is an organic compound, i.e. a carbon chemistry based synthetic compound with metallic properties, e.g., polyphenylenamine-para-toluene-sulfonic acid polysalt.

However the inability to assess the solderability of the OSP-coated copper and the integrity of the OSP itself interfere with the reliable application of these preferred coatings. These difficulties are compounded by the limited shelf life of the OSP, and its potential degradation during reflow operations.

A novel approach for protecting metal surfaces, for example, a copper printed circuit board is to apply a chromate conversion coating over the base metal. The application of chromate coatings are already within the skill of the art as having been used to protect copper pads on printed wiring board applications and as a corrosion inhibitor on aluminum substrates. The advantage of applying a chromate coating to a metal substrate is that any initial oxidation or corrosion which may have occurred on the substrate is etched away during the application of the chromate coating. Moreover, the possibility of the formation of intermetallics is eliminated by the use of said protective coating. An additional benefit realized from using the chromate coating is that said coating is easily and readily removed from the substrate during processing, e.g. soldering. Use of a chromate protective coating, however, only slows down the oxidation process which has substantial affects on the solderability properties of a base metal. Therefore, solderability testing methods are still very much in need.

Currently, solderability of a PCB is measured by testing coupons attached to the PCB while components are tested by testing their actual leads. This is accomplished by applying solder to the coupon or component lead and then examining it for a variety of parameters such as area of spread, dewetting, wetting force and wetting time. For PCBs, this is an indirect test and does not give a true solderability measure of the board itself. For components, it requires the actual application of solder to the leads prior to the actual soldering step. Moreover, these tests tend to be subjective in nature and therefore not very reliable.

Another procedure for testing and measuring the solderability of a circuit board is a technique called electrochemical reduction. Although this technique does not involve the application of solder onto the component part to be evaluated, it requires the application of a reducing agent to remove surface oxides and physically affects the component part. U.S. Pat. Nos. 5,425,859; 5,401,380; and 5,262,022 teach sequential electrochemical reduction analysis (SERA), an apparatus for assessing solderability of electronic components (see for example commercial apparatuses relating to these technologies at the website address www.ecitechnology.com). The method detects and quantifies the presence of metallic oxides and other corrosion products that are detrimental to solderability by sequential electrochemical reduction in contact with an electrolyte in an inert atmosphere. A cathode having a high hydrogen overvoltage is placed in contact with the electrolyte. A solderable portion of the component to be tested is placed in contact with the cathode and the electrolyte. An inert counter electrode and a reference electrode are also placed in contact with the electrolyte. A constant current is passed between the cathode and inert electrode, and the voltage is measured as a function of time during reduction of metallic oxides on the solderable portions of the component. The measurements of voltage, current, time, and charge density compared with baseline data from specimens having known oxide compositions that correlate with degradation of solderability. U.S. Pat. No. 5,466,349 discloses a method of Potentiometric Evaluation of Substrate Oxidation (PESO) in which a coated part to be analyzed is placed in contact with an electrolytic solution having a pH adjusted to provide an optimum oxide dissolution rate. The open circuit potential of the part is monitored as the substrate oxide dissolves in the electrolytic solution. The voltage typically changes as a function of time during oxide dissolution.

U.S. Pat. No. 4,409,333 discloses a method for evaluating the solderability properties of molten solder. In the method of this invention, a test piece is provided which has a transparent support with a film of metal such as copper deposited on one surface of the transparent support. The surface having the metal film is immersed in the molten solder and the time required for alloying to occur and be observed through the transparent support is measured to determine rate of alloying and, thereby, the solderability properties of the molten solder under evaluation.

Light interference patterns in the copper oxide system were first studied by Hummel in 1975 . Subsequently, Urban et al. (1981) demonstrated that the longest wavelength peak of the interference spectrum can be calculated from the expression: λ≅5nd; where λ=the wavelength of the major spectral feature; n=the index of refraction of the oxide (reported as 1.6 for copper oxides, per Urban, although others report this value variously, up to 2.7); and d=the thickness of the oxide layer (nm). U.S. Pat. Nos. 3,482,161, 3,440,529, and 3,448,380 use spectroscopic methods of sample analysis. The derivation of the principle of monitoring an oxide coating thickness by spectroscopy methods is disclosed in U.S. Pat. No. 5,357,346 and references therein. This patent shows a relationship between the intensity of the reflectance spectra of copper and the thickness of cuprous and cupric oxide on the copper surface as a measure of solderability qualities of a substrate. However, this patent does not teach or suggest a method of measuring the solderability of OSP or chromate coated metals which have completely different spectral characteristics.

Thus, to date, a method of directly determining the solderability of a metal substrate which has been coated with a film has not been proposed. It is clear that improved solderability test methods will lead to improved manufacturability and reliability in microelectronic devices. As set forth above, the existing solderability testing techniques have their limitations. Most techniques require that the sample being tested be physically altered. A reflectance method has been disclosed for bare copper parts. However, this method does not teach or suggest a method of measuring the solderability of coated metals which have completely different spectral characteristics. Thus, it would be desirable to provide a method of assessing the solderability of coated metal parts that does not require physical alteration of the sample being tested.

### SUMMARY OF THE INVENTION

The present invention provides a methodology for gauging solderability and is a procedure that may be used on various base metals and coatings. The present invention does not have any adverse limitations on its operability. It does not involve the application of any solder and does not physically alter the component to be evaluated. Moreover, the present invention tests the component directly and does not require the use of test coupons or electrodes or chemicals. Use of the present invention facilitates the expeditious and efficient inspection of the solderability property of coated metals. The present invention provides a simple method to assess solderability of coated, e.g., OSP-coated, metals. This method may be used to evaluate the solderability properties of a circuit board, for instance.

The present invention is directed to a method for evaluating the solderability of metals found, for example, in printed wiring or circuit boards. It is a method which may be exercised on a variety of base metals and coatings; it does not physically affect the component; it eliminates the need for the use of test coupons or other complicated means of solderability testing; and it permits a reliable and quick inspection of the component for its solderability qualities.

The method of the present invention uses differential reflectometry techniques and provides determination of oxide thickness on preservative-coated component. In addition, the present invention makes use of the correlation between the oxide thickness present and the solderability of the component base material or coating in order to gauge the component's solderability in terms of its reflectance. To date this technique has not been used to determine and evaluate solderability properties of coated metals.

It is further object of the present invention is to provide a thorough, expeditious and efficient method for testing the solderability properties of a base metal or coatings thereon. Base metals and alloys thereof can be any of industry used metals. Similarly, OSPs are any of art-accepted OSPs.

Another object of the present invention to provide a method of testing solderability of metals, wherein said metals are chromate passivated.

It is further object of the invention is to provide a method for testing the solderability of a circuit board wherein said method does not physically alter or affect the circuit board.

Still another object of the present invention is to provide a method for testing the solderability of a device, wherein said method eliminates the use of test coupons or other means of solderability testing.

It is another object of the present invention to provide an apparatus and software capable of spectrophotometric determination of solderability of sample metals.

Other objects, features, and advantages of the invention will become evident in light of the following detailed description considered in conjunction with the referenced drawings of preferred exemplary embodiments according to the present invention.

### BRIEF DESCRIPTION OF FIGURES

FIG. 1 shows an integrated process control system;

FIG. 2 shows bare copper (Cu°) aged at 150° C. wherein the predominant feature in the reflectance spectra of Cu° changes in intensity and shifts to higher wavelength with increasing time at 150° C. (baselines corrected for diffusion and slope, and zero points shifted for comparison purposes);

FIG. 3 is a plot of Cu° aged at 150° C. showing the wavelength of the major spectral feature against time;

FIG. 4 shows OSP-Cu aged at 150° C. wherein changes in the reflectance spectra of OSP-Cu upon oxidation at 150° C. are complex, and features are less pronounced than are observed with Cu° (baselines corrected for diffusion and slope, and zero points shifted for clarity);

FIG. 5 shows OSP-Cu aged at 150° C. wherein the relative absorbance provides a diagnostic measure of surface changes related to solderability;

FIG. 6 shows OSP-Cu aged at 150° C. comparing solder wetting, reduction potential and relative absorbance (wherein, for clarity, the measured values are scaled to the %-age of their maximum value during the time period of interest);

FIG. 7 shows OSP-Cu aged by successive reflow comparing solder wetting, reduction potential and relative absorbance (wherein, for clarity, the measured values are scaled to the %-age of their maximum value during the time period of interest); and

FIG. 8 shows OSP-Cu aged at 85°C., 85% relative humidity comparing solder wetting, reduction potential and relative absorbance (wherein, for clarity, the measured values are scaled to the %-age of their maximum value during the time period of interest).

### DETAILED DESCRIPTION OF THE INVENTION

The term “solderability” as used herein refers to the ability of a metallic surface to be wetted by molten solder to form a metallurgical bond or the ease with which molten solder wets the surfaces of the metals being joined. The term “wetting” means the way as to how the molten solder leaves a continuous permanent film on the metal surface.

While spectroscopic method of evaluating the solderability of non-coated metals is known there are no simple methods to assess solderability of coated base metals. The invention herein is a method for evaluating, predicting and testing the solderability characteristics of coated base metals, for instance in printed wiring boards (PWBs) or printed circuit boards (PCBs).

The present method is equally suitable for wide range of OSPs. Specific examples of OSPs include, but are not limited to benzimidazole, 2-methylbenzimidazole, 5-methylbenzimidazole, 5,6-dimethylbenzimidazole, 2-propyl-4,5-dimethylbenzimidazole, 2-butyl-5-nitrobenzimidazole, 2-pentyl-5,6 dichlorobenzimidazole, and 2-heptadecyl-5-methylbenzimidazole. The 2-alkylbenzimidazole derivatives suitable for practice of the present invention may be 2-propylbenzimidazole, 2-butylbenzimidazole, 2-pentylbenzimidazole, 2-hexylbenzimidazole, 2-heptylbenzimidazole, 2-octylbenzimidazole, 2-nonylbenzimidazole, 2-undecylbenzimidazole, 2-isobutylbenzimidazole, 2-(1-methylbutyl)benzimidazole, 2-(1-ethylpropyl)benzimidazole, 2-(1-ethylpentyl)benzimidazole, 2-(2,2-dimethylpropyl)benzimidazole, 2-(3-methylbutyl)benzimidazole, 2-(2-propylbutyl)benzimidazole, 4-methyl-2-heptylbenzimidazole, 4-chloro-2-octylbenzimidazole, 4,5-dimethyl-2-pentylbenzimidazole, 4,5-dichloro-2-hexylbenzimidazole, 4-methyl-2-(1-ethylpentyl)benzimidazole, 4-chloro-2-(3-methylbutyl)benzimidazole and salts thereof. Other OSPs as for example disclosed in U.S. Pat. Nos. 5,658,611; 5,858,074; 5,795,409; 5,735,973; 3,933,531; 4,373,656; 5,173,130; 5,960,251; 5,960,251; 5,498,301; and 5,496,590 are equally suitable.

OSP coatings are usually applied from a weak acid solution (referred to hereinafter as an OSP solution) through formation of a complex between the azole and the copper surface. Unlike tin-lead coatings, OSP coatings are essentially invisible to the naked eye. Thus, conventional absorbance based methods such as disclosed in U.S. Pat. No. 5,357,346 will fail since they do not account the additional light-interfering layer created by OSP.

The method within the scope of the present invention makes use of conventional differential reflectometry. Differential reflectometry is a form of modulation spectroscopy which measures the normalized difference in reflectivity between two samples, or two adjacent areas of the same sample, or of the same sample over a period of time. A conventional differential reflectometer of the type which can be employed herein is described and depicted in C. W. Shanley et al., “Differential Reflectometry—A New Optical Technique to Study Corrosion Phenomena,” Corrosion Science, Vol. 20, pp. 467-480 (1980). The process of differential reflectometry has been used to determine oxide thickness and oxide type. This process, however, has been applied primarily in corrosion studies. It has not been applied in any manner to predict or evaluate solderability, especially the solderability of coated metal surfaces.

To date, this correlation is nowhere suggested in the prior art teachings. This invention provides a means using the relationship between reflectance and oxide thickness and the relationship between oxide thickness and solderability to gauge and evaluate the solderability properties of various substrates, such as printed circuit boards or printed wiring boards. However, unlike prior art methods such as disclosed in U.S. Pat. No. 5,357,346 this invention does not require the actual measurement of oxide thickness.

In the present invention, the solderability properties are evaluated using the following parameters: differential reflectivity measurement, index of refraction, index of absorption and correlation between oxide thickness and solderability or by directly correlating the differential reflectivity measurement and solderability. To date, there is no solderability test available that correlates directly the reflectance and solderability.

The solderability testing method herein uses a conventional differential reflectometer. According to one embodiment, an un-polarized white light source is used to produce wavelengths of 200 to 800 nm. The emitted light is passed through various components of the differential reflectometer. For example, the un-polarized white light may pass through a monochromator and onto a set of mirrors which reflect the light onto the sample component to be analyzed. The light is reflected off of the sample through another set of mirrors and to a photomultiplier. The photomultiplier then provides an electronic signal which is processed in a conventional fashion to calculate at least two sets of reflectance values at, at least two wavelengths.

A reference standard is used to calibrate the system. A control sample, which is of the same material as the sample component being evaluated, is chosen to accommodate the material to be evaluated using the present invention. This control sample will either have no oxide layer present on its surface or it will have a known amount of oxide present. Reflectance values generated using the control sample are used in evaluating the sample being tested.

Any base material that can be worked by cold-rolling can be tested by instant methods. Commonly used base materials are the wide variety of copper alloys such as cupro nickels, phosphor bronzes, brasses, and nickel silvers. Stainless steels, aluminum alloys, nickel alloys, and others can be tested as well. Alloys containing volatile elements, such as zinc, are equally acceptable.

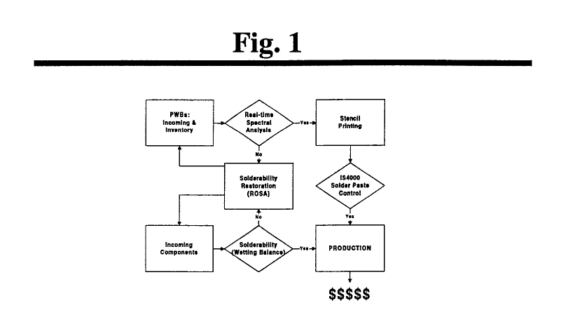

The utility of a spectrographic process is to provide the capability for immediate Go/No-Go decisions (real time spectral analysis) regarding board solderability before proceeding with stencil printing, component placement and reflow. Use of marginally solderable boards in production risks large monetary rework expenditures. Further, if the spectral analysis indicates a potential failure (No-Go), solderability can be restored by reduced oxide solderability assessment (ROSA) process. FIG. 1 illustrates an integrated process control system, including an IS4000 Process Control Tool that uses electrical impedance spectroscopy to determine solder paste printing and reflow properties.

### EXAMPLE 1

Description of samples and data collection

UV-Visible reflectance spectra are obtained using a software program (Pentium processor) to control an Ocean Optics SD2000 dual fiber spectrometer and DT-1000S tungsten-deuterium light source impinging a 5.3 mm² area normal to the target through a fiber optic probe, with automatic referencing to an NIST certified diffuse white reference standard. The probe placement is monitored using a 7 mm Elmo-QN42HL microcamera with a 4 mm lens mounted in the probe holder a 45° angle to the target. Internal background intensity calibration utilizes the constant silicon-tungsten absorbance peak at 655 nm.

OSP studies utilize standard 1″×2″×027″ test coupons, coated with Entek Plus CU-106A (a benzimidazole derivative) by Raytheon Systems Company with an OSP thickness of 0.21 μm. Bare copper samples are cut from 1″>0.022″industrial copper foil and pickled with 10% H2SO4 to remove oxides and passivating agents. Commercial OSP-coated PCB's are utilized for reflow studies. All samples are stored under nitrogen when not actively undergoing aging or analysis.

### EXAMPLE 2

Sample aging methods

Aging methods used in this invention include a (1) dry air (oven) at 150°±1°C., (2) humidity chamber set to 85° C. at 85% relative humidity, and (3) repeated passes through an Omniflo7 Electrovert Convection Reflow Oven using a time/temperature profile typical for PCB reflow operations, with a maximum temperature zone of 240° C. for 42 seconds, in air.

### EXAMPLE 3

Solderability assessment by conventional methods

Two methods were used to assess solderability; solder wetting and electrochemical reduction potential of the test piece. For the solder wetting test a Multicore Must-II wetting balance was used with 63/37 Sn/Pb solder at 245° C. and immersion speed of 10 mm/sec to a 5 mm depth, with an immersion time of 10 sec. Typically, the flux used is Multicore ACTIEC-5, which contains 5% halide activators. The criteria for wetting is the time in seconds to achieve a 90° contact angle following sample immersion.

For the second method sequential electrochemical reduction analysis (SERA) was performed using an ECI Technology QC-100 chronopotentiometer with a de-aerated, pH 8.4 solution of borate buffer at a current density of 50 μA/cm². In appropriate systems the plateau voltage reflects the nature of a metal oxide, the charge passed is a measure of the amount of oxide present and, for OSP coated copper, the final voltage is a measure of the integrity of the OSP coating.

### EXAMPLE 4

Measurement of solderability of bare copper (Cu°).

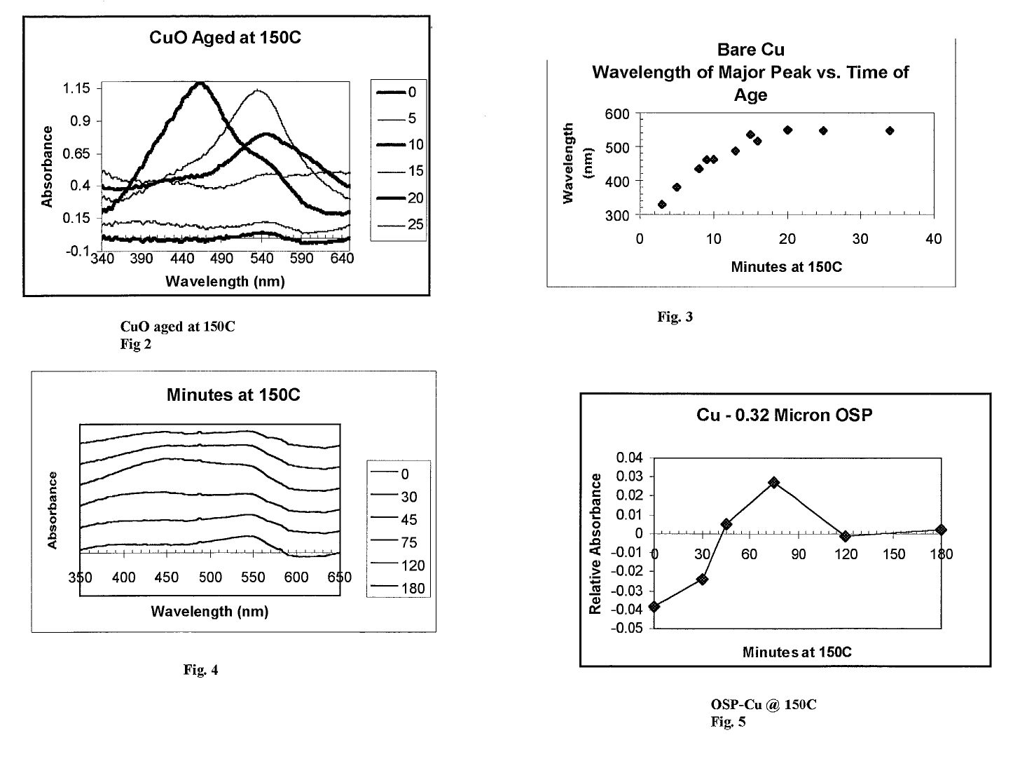

The reflectance spectra of bare copper (Cu°) rapidly undergoes marked changes in the UV-visible region upon heating. This is consistent with the visible color changes of copper that are readily apparent to the naked eye upon ambient aging or heating. The various colors that develop on copper during oxidation are associated with specific thicknesses of a growing oxide layer. The UV-visible spectrum of Cu° is characterized initially by formation of an absorbance peak at 420 nm after 5 minutes at 150° C., as shown in FIG. 2. This is not a fixed absorbance however, and with additional time the peak intensity increases and the peak maximum shifts to higher wavelength, reaching a maximum intensity at approximately 500 nm in 12 minutes. The absorbance at 500 nm is consistent with the yellow color of copper as it oxidizes under these conditions. At longer heating times, the peak maximum decreases in intensity and continues to shift to higher wavelengths until, after 25 minutes at 150° C., the peak is found at 640 nm.

The shift in the wavelength of the major feature of the Cu°-Cu oxide spectra overwhelms the spectral features that can be ascribed to specific chemical species and even the strong diffuse absorption band at 300-550 nm, at least in the time period of interest for the determination of solderability parameters. As a result, a straightforward analysis of the oxidation process can be constructed from the shift in the wavelength of the major feature against time, as shown in FIG. 3.

As noted above the interference patterns in the Cu°-Cu oxide system were first studied by Hummel in 1975. Subsequently, Urban et al. (1981) demonstrated that the longest wavelength peak of the interference spectrum can be calculated from the expression: λ≅5nd; where λ=the wavelength of the major spectral feature; n the index of refraction of the oxide (reported as 1.6 for copper oxides, per Urban, although others report this value variously, up to 2.7); d=the thickness of the oxide layer (nm). Inserting an index value of 1.6 into this expression with the major interference peak ranging from 300 nm to 600 nm, the oxide thickness is calculated to increase from 37 to 75 nm. Using an index value of 2.7, the calculation indicates an oxide thickness of 22 to 44 nm. Independent thickness calculations (see Example above) that derive from the measured reduction potential (SERA) are in positive agreement with these numbers, indicating a maximum oxide thickness of 200 nm from the same aged samples.

Thus, while the oxidation of Cu° provides invaluable insight for the spectral interpretation of the Cu°-Cu oxide system, it is of limited direct practical value to the PCB manufacturer who is concerned about the solderability of copper that has been already coated to retard or prevent oxidation. For this reason, this invention is mainly concerned with the interpretation of the spectra of OSP-coated copper.

### EXAMPLE 5

Solderability assessment of coated metal.

The reflectance spectra of OSP-coated copper is much more complex than that of bare metal, e.g., Cu°. A corresponding shift of wavelengths through the 350-600 nm region is found to occur with aging of coated metals, and this strongly suggests that optical interference phenomena are an important feature of this system as well. However, the intensity of the observed peaks are reduced by about 90% of what is observed with bare copper. As a result, there is much more interference from the background diffusion band of copper and there is no major spectral feature which can be clearly followed as it shifts across the measurement range. The problem is illustrated by comparison of the strong features of the Cu° system in FIG. 2 with the weaker peaks of the OSP-Cu samples as shown in FIG. 4. Thus, changes in the reflectance spectra of OSP-Cu upon oxidation at 150° C. are complex, and features are less pronounced than are observed with Cu°.

To overcome this problem of spectral interpretation, the present invention provides at least two preferred embodiments (see methods I and II, below) for the analysis of the OSP-Cu system using UV-visible reflectance spectra in order to correlate aging with solderability. Both are equally useful in establishing a Go/No-Go criteria for PCB solderability (see FIG. 1).

### EXAMPLE 6

Specific methods I and II.

The method I is derived from the interpretation of the interference spectrum. This method utilizes at least two reference wavelengths to follow the aging process in the oxide region (350-600 nm). The absorption at 450 nm is taken as a measure of initial oxidation processes, and the absorption at higher wavelength, e.g., 540 nm is taken as a measure of later oxidation processes. For the analysis, the raw spectral data are corrected for baseline shift and slope, and then the absorption at 540 nm is subtracted from the absorption at 450 nm to yield a relative absorbance. The relative absorbance value, which may be either positive or negative number due to the baseline correction and peak intensity ratios, is sensitive to the spectral disturbance caused by residual copper oxide interference phenomena.

The second approach, method II, follows the decrease in the characteristic benzimidazole OSP absorption peak during aging, after correcting for baseline shift. For consistency in data presentation (i.e, measured values increasing with time), the reciprocal of the measured absorption is plotted. Benzimidazole exhibits a diagnostic peak at 270 nm, a wavelength that is transparent to the other species in the system and is itself essentially free from interference patterns. The decrease in absorption at 270 nm upon heat aging of benzimidazole coatings is consistent with the “deterioration or reorganization” that has been inferred from the increasing final voltage found in prior SERA aging studies. Such OSP aging processes may include the slow volatilization of the benzimidazole under the heating conditions, polymerization, or chemical changes that alter the energy state of the benzimidazole or its copper complex. When held at 150° C. for ≧50 hours, the benzimidazole absorbance at 270 nm disappears entirely. This method permits measurement of not only the aging of OSP, but also the presence or absence, i.e., “amount,” of OSP on the metal or substrate surface.

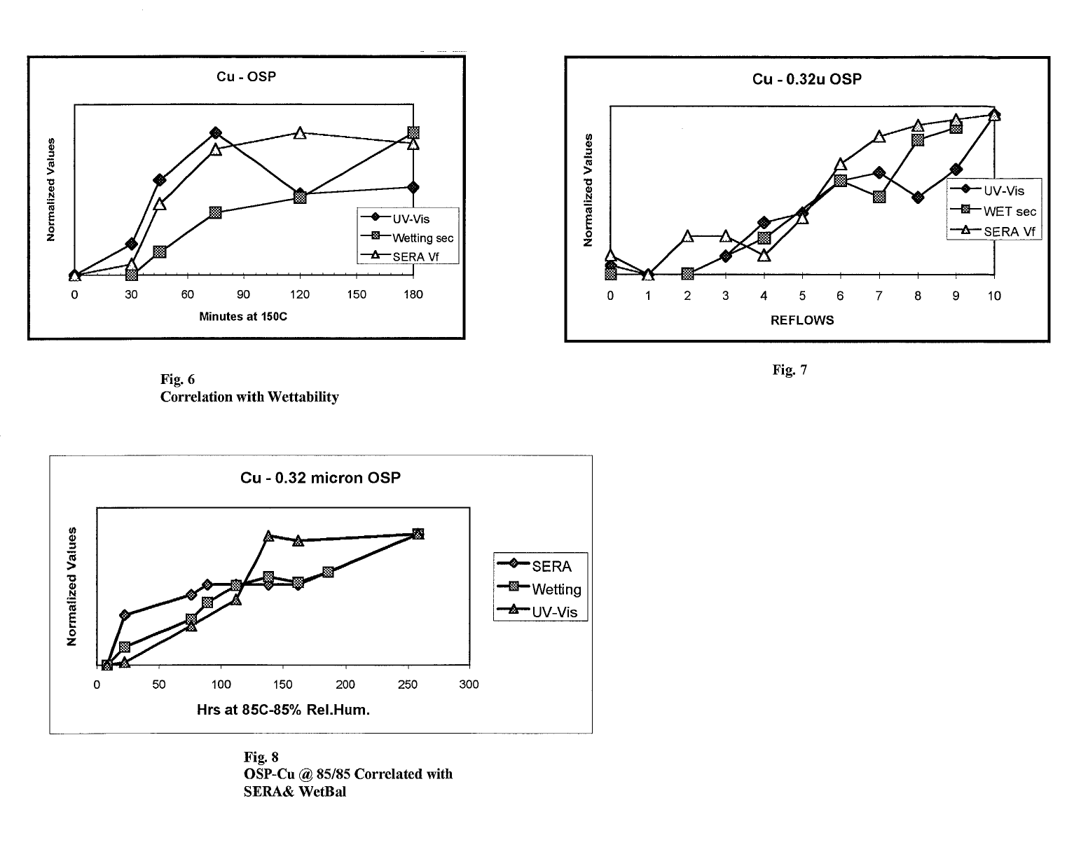

The application of method I is shown in FIG. 5 for coupons with an 0.21 μm layer of benzimidazole, aged at 150° C. The unusual shape of the curve plotted against time reflects the interference pattern which overlays the discrete wavelength absorbances of the copper oxides. At even longer time periods the relative absorbance value exhibits a cyclic pattern, typical of interference spectra. Fortunately, in the copper-copper oxide system it is the first cycle that is diagnostic for solderability. To calibrate the relative absorbance value derived by method I against solderability, the same 150° C. aged coupons are analyzed by their reduction potential (SERA), and solder wetting. Both these measurements of solderability are highly dependent on the substrate and the experimental parameters chosen for the test. The most effective utilization of these tests, therefore, utilizes conditions under which the maximum rate of change against time occurs at the boundary between good and poor solderability. As shown in FIG. 6, it can be seen that the maximum rate of change in both the reduction potential and solder wetting occurs at approximately 40 minutes at 150° C. Correspondingly, both methods I and II are also at their most sensitive (most rapid change with aging) in the same spectral region, indicating that wetting balance, SERA, and spectral measurements are indeed supportive of changes in the OSP-copper substrate observed by instant methodology.

Analysis of test coupons and commercial PCBs passed through a reflow oven from one to ten times gave similar results: the relative absorbance of coupons heated at a steady 150° C. for 75 minutes (FIG. 5) are comparable with the corresponding relative absorbance that occurs after 6-7 reflow passes (FIG. 7). In both cases method I exhibits a similar discontinuous spectral curve, and the regions of greatest sensitivity (maximum change of values with unit aging time) of all these methods overlap.

Coupons aged at 85° C. and 85% relative humidity exhibited a lower rate of oxidative change, as shown in FIG. 8. A similar spectral pattern is again seen for all three techniques, in that the spectral values increase in accord with the SERA and wetting balance values. This is true even though the spectral intensity values are shifted to higher values in the high humidity system (not apparent in FIG. 8, as a consequence of normalizing the data).

Solder wetting is a generally accepted measurement technique for solderability. The value chosen as diagnostic for good solderability depends on the specific system under consideration, but a value of 2 seconds to achieve a 90° contact angle is common for many systems. Accordingly, the relative absorbance (method I) for the aging studies when wetting time=2 sec. and for the disappearance of the 270 nm peak (method II), are shown in Table I, below. We had hoped to find consistent values across the systems when wetting time=2 sec. Good agreement is demonstrated between relative absorbance and wetting for coupons aged in a humidity chamber and by successive reflow (0.007 and 0.01, respectively). However, there is less agreement with coupons aged at 150° C. (−0.025). Similarly, the 270 nm values are in agreement for the reflow and 150° C. aging (−0.075 and −0.074), but not for the high humidity aging (−0.052).

The results indicate that while the spectral data successfully depicts the occurrence and progression of copper and OSP-copper aging, the values obtained are dependent on the experimental aging conditions.

TABLE I
Spectral Values at Wetting Time* = 2 sec.

| Aging Condition | Aging Time | Method I | Method II |
|---|---|---|---|
| Reflow (240° C.) | 3 x | +0.01 | −0.075 |
| 85° C.-85% relative humidity | 76 hr | +0.008 | −0.052 |
| 150° C. | 45 min | −0.025 | −0.074 |

*245° C. solder bath, flux = ACTIEC-5 at 10 seconds test duration

The correctness of the methods of the present invention may be examined by additional spectroscopic methods. These methods included ellipsometry and near infrared, Raman and infrared spectroscopy. While these methods are equally suitable for the intended purpose, the preferred method is UV-visible spectroscopy. UV-visible reflectance spectroscopy provides an effective means of determining the changes in the surface of copper as it undergoes aging. Two spectral analysis methods have been explored, both of which show similar trend data for solderability as the wetting balance and SERA.

### EXAMPLE 7

Software design based on experimental data

In order to utilize the raw spectral data received from the target surface to assess solderability of an OSP-coated surface, the following procedure is applied: two characteristic wavelengths, A and B are selected, where A is typically a lower wavelength than B. These two characteristic wavelengths, A and B are selected such that the intensity of A varies with incipient changes in the solderability of the test system, and the intensity of B varies with intermediate changes in the solderability of the system. Additional wavelengths C and D are chosen wherein C is a wavelength that is lower than A and does not vary with solderability, and D is a wavelength that is higher than B and does not vary with solderability. It is preferable to choose values of C and D that are close to A and B, still meeting the criteria that they do not vary with solderability and remain constant. The baseline of the spectrum is normalized using the reference points C and D by setting both reflectance values equal to zero. This has the effect of correcting the baseline for variability in shift and slope, thus adjusting the raw values of A and B. The difference between the adjusted values of A and B now provides a number which is directly related to the solderability of the target surface. In general, when the calculated number increases, the solderability decreases. The foregoing procedure has been incorporated into the design of the software that may control an apparatus and displays the results of the analysis.

A preferred embodiment of the software is a formula that corrects reflectance values for baseline shift and slope as indicated above:

R′_{λ}=R_{λ}−R_{C}[(D−λ)/(D−C)]−R_{D}[(λ−C)/(D−C)]

where:

R′_{λ}=the corrected reflectance at the wavelength λ;

R_{λ}=the measured reflectance at the wavelength λ;

R_{C}=the measured reflectance at the wavelength C;

R_{D}=the measured reflectance at the wavelength D;

C=the lower wavelength chosen to normalize the baseline; and

D=the higher wavelength chosen to normalize the baseline.

For example;

for the reflectance at λ=450, with baseline correction.

R′₄₅₀=R₄₅₀−0.645 R₃₄₀−0.355R₆₅₀

and the reflectance at λ=540, with baseline correction.

R′₅₄₀=R_{540 -}0.355 R_{340 -}0.655R₆₅₀.

The Solderability (S) is then predicted by;

S∝R′₄₅₀ −R′₅₄₀

In the preferred embodiment, the software is a menu driven software package with several menus which provides the user with the ability to utilize a database for setup, result storage, and to collect and analyze the data.

The exemplary first menu item allows the user to setup the database table. The information which can be defined within this table includes the Manufacturer, Model Number, . The Manufacturer and Model Number identify this record in the database. The equations above are used to characterize the solderability.

The second menu item allows the user to define the solderability inspections. The information which may be entered includes the Solderability ID (Manufacturer and Model Number), Lot name\Number, Measurements, Data File, Solderability Control Setup, and various other Data Files. Each record in the inspection table is identified by the Lot Numberor name.

The third menu, for example, allows the user to perform the calibration. The following can be specified to collect data, Frequency Range, , Background Level, Instrumentation settings, etc. Once the user has selected a sample, the control parameters are loaded into the global memory so that other features of the software may use them.

The fourth menu allows the user to perform the solderability test. The first action required is to collect the data from the spectrometer over a variety of light frequencies or wavelengths. Once the data is collected, it is characterized through the method I and II analysis calculations The resulting solderability values from the calculations are stored in the database record related to the Lot ID Name/Numberand displayed on the corresponding graphs.63 A model flow chart of a possible process control line utilizing the solderability assessment tool is shown in FIG. 1.

### EXAMPLE 8

Assembly of an apparatus of the invention

Several spectroscopic instruments or apparatuses are assembled utilizing this technology for field trials in the production environment. These instruments consist essentially of a spectrophotometer wherein collected data is analyzed by the software described herein. Additionally, it contains a microcamera for monitoring the sample placement. It further comprises a background intensity calibration unit that utilizes the absorbance peak at about 655 nm.

The software of the invention incorporates the algorithms generated by experimental data of the invention and upon analysis of the test sample provides the reliable assessment of solderability (see examples above).

The scope of the present invention encompasses the effect of variation in the benzimidazole-like OSP thickness for the spectral measurements and takes into account the oxidative degradation of other types of OSP and chromate coatings in addition to benzimidazole-like OSPs. Method I alone or in combination with Method II provides a measure of solderability with a high degree of generality across PCB and component systems, OSP types, and manufacturing environments.

It is to be understood, however, that the invention is not limited to the specific features shown, since the means and construction herein disclosed comprise a preferred form of putting the invention into effect. The invention is, therefore, claimed in any of its forms or modifications within the proper scope of the appended claims, appropriately interpreted in accordance with the doctrine of equivalents.

What is claimed is:

1. A method for evaluating the solderability of a coated metal surface comprising steps of:
(a) providing at least two reflectance measurements of the coated metal surface for which the solderability evaluation is desired; and
(b) correlating said at least two reflectance measurements to the solderability of the coated metal surface.

2. The method of claim 1 in which the coating of the metal surface is an organic solder preservative coating.

3. The method of claim 1 in which the coating of the metal surface is a chromate coating.

4. The method of claim 1 in which the metal is copper, nickel, palladium, aluminum, gold, silver, lead, tin, solder or combinations thereof.

5. The method of claim 1 in which the at least two reflectance measurements are obtained by using two reference wavelengths, wherein one of the reference wavelengths is lower than the other.

6. A method for evaluating the solderability of a sample comprising the steps of:
(a) collecting reflectance measurement values of the sample at two reference wavelengths A and B, wherein A is a lower wavelength than B;
(b) normalizing A and B measurement values for baseline shift and slope; and
(c) determining the solderability of the sample by subtracting the normalized value of A from the normalized value of B.

7. The method of claim 6 in which the sample is a metal.

8. The method of claim 7 in which the metal is coated with an organic solder preservative.

9. The method of claim 7 in which the metal is coated with a chromate.

10. A method for evaluating the bonding property of a coated metal to which a metal bonding wire is to be bonded, comprising the steps of:
(a) projecting a light beam onto the surface of the coated metal;
(b) receiving a reflection from said surface of the coated metal;
(c) obtaining at least two reflection intensity distribution curves;
(d) normalizing said two reflection intensity distribution curves for baseline shift and slope; and
(e) determining the bonding property of the coated metal of interest.

11. A method for evaluating the amount of an organic solder preservative or corrosion inhibitor on the surface of a substrate, said method comprising steps of: P1 (a) collecting an absorbance measurement at a wavelength essentially free of light interference; and
(b) relating the absorbance measurement to the amount of organic solder preservative or corrosion inhibitor.

12. The method of claim 11 in which the wavelength which is essentially free of light interference is at about 270 nm.

13. The method of claim 11 in which the substrate is a metal.

14. The method of claim 13 in which the metal is copper, nickel, palladium, aluminum, gold, Silver, lead, tin, solder or combinations thereof

15. The method of claim 11 in which the organic solder preservative is selected from the group consisting of benzimidazoles, imidazole, alkylimidazoles, benzotriazole and alkyltriazoles, substituted and unsubstituted derivatives thereof, and chromates.

16. An apparatus useful for evaluating a solderability of a coated metal surface in a sample comprising:
(a) a spectrophotometer; and
(b) software adapted to normalize at least two reflectance light measurements from the sample and to numerically combine values of said normalized reflectance light measurements to determine the solderability of the sample.

17. The apparatus of claim 16 wherein the software is located in an external computer communicating with the spectrophotometer.

18. The apparatus of claim 16 which further comprises a microcamera for monitoring the sample placement.

19. The apparatus of claim 16 which further comprises a background intensity calibration unit.

20. The apparatus of claim 16 in which the background intensity calibration unit utilizes an absorbance peak at about 655 nm.

21. The apparatus of claim 16 wherein the software is capable of processing and comparing a light spectrum of the sample with a set of control spectra collected from at least one control metal sample, said at least one control metal sample having a known solderability and determining from the comparison the solderability of the sample.

22. The apparatus of claim 16 in which the evaluation of the solderability of a sample comprises the steps of:
(a) illuminating the sample with a light;
(b) measuring at least two reflectance spectra; and
(c) estimating the solderability of said sample.

23. The apparatus of claim 18 in which said estimating step (c) is based on the relationship of a corrected reflectance value at a selected wavelength and a corrected reflectance value at a dissimilar light wavelength.

24. The apparatus of claim 23 wherein the selected wavelength is from about 270 to about 650 nanometers.
